(19) United States
(12) Patent Application Publication
(10) Pub. No.: US 2021/0042278 A1
(43) Pub. Date: Feb. 11, 2021

(54) TRANSFORM OPTIMIZATION FOR PERFORMANCE OPTIMIZED DATA WAREHOUSE

(71) Applicant: Hitachi, Ltd., Tokyo (JP)

(72) Inventor: Masanori TAKADA, Santa Clara, CA (US)

(21) Appl. No.: 16/535,655

(22) Filed: Aug. 8, 2019

(51) Int. Cl. G06F 16/21; G06F 16/2458; G06F 16/2453; G06F 11/34

(52) U.S. Cl. CPC G06F 16/217; G06F 11/3409; G06F 16/24542; G06F 16/2465

(57) ABSTRACT

Example implementations described herein are directed to conducting data transform optimization for utilizing special hardware such as field programmable gate arrays (FPGAs) or graphics processor units (GPUs) to facilitate the processing of SQL queries, based on the characteristics of the workload of the system and the penalty of conducing the transform itself. Example implementations then process SQL queries through using special hardware or general hardware based on the determination, and also can transform SQL queries for processing on special hardware.

### BACKGROUND

### Field

The present disclosure is generally directed to data analytics systems, and more specifically, for transform optimization of computing resources for performance optimized at warehouses.

### Related Art

Big data analysis is utilized for many purposes. In the enterprise environment, the data warehouse or Hadoop environment are used for storing data and running analysis. There are many types of analytics running on these environments, but Structured Query Language (SQL) type of query is one of the workloads that is used.

There are many types of computing resources that can be utilized to facilitate big data analysis. For example, central processing units (CPUs) are one type of computing resources that is used for general purpose computing. Graphics Processor Units (GPUs) or Field Programmable Gate Arrays (FPGAs) are also used for more specific workloads since such hardware components are optimized for specific functions. These components are often called “hardware accelerators”, since they accelerate the computing workload by offloading a part of the workload from the CPUs.

In related art implementations, there are hybrid computing systems including FPGAs and CPUs involving an orchestrator that monitors resource utilization and workload, and also decides when the application is to use FPGAs or only CPUs based on the monitoring information.

In related art implementations, there is also an information system using FPGA for conducting partial operations for SQL query operations. Such related art systems receive queries from application servers, break down the queries to multiple operations, and dispatch each of the operations to either CPU (software) or FPGA.

### SUMMARY

Aspects of the present disclosure can involve a method involving receiving a history of a Structured Query Language (SQL) query, the history including transform operations associated with the SQL query and query operations associated with the SQL query; determining a penalty for modifying the transform operations and the query operations associated with the SQL query; and based on the history of SQL queries, modifying the transform operations and query operations associated with the SQL query for the penalty not exceeding a threshold.

Aspects of the present disclosure involve a non-transitory computer readable medium, storing instructions for executing a process, the instructions involving receiving a history of a Structured Query Language (SQL) query, the history comprising transform operations associated with the SQL query and query operations associated with the SQL query; determining a penalty for modifying the transform operations and the query operations associated with the SQL query; and based on the history of SQL queries, modifying the transform operations and query operations associated with the SQL query for the penalty not exceeding a threshold.

Aspects of the present disclosure can involve a system involving means for receiving a history of a Structured Query Language (SQL) query, the history including transform operations associated with the SQL query and query operations associated with the SQL query; means for determining a penalty for modifying the transform operations and the query operations associated with the SQL query; and based on the history of SQL queries, means for modifying the transform operations and query operations associated with the SQL query for the penalty not exceeding a threshold.

Aspects of the present disclosure can involve a management server, configured to manage a system involving general hardware for conducting general analytics on a data lake, and special hardware for conducting special analytics on a data warehouse, the management server involving a processor, configured to receive a history of a Structured Query Language (SQL) query, the history involving transform operations associated with the SQL query and query operations associated with the SQL query; determine a penalty for modifying the transform operations and the query operations associated with the SQL query; and based on the history of SQL queries, modify the transform operations and query operations associated with the SQL query for the penalty not exceeding a threshold.

### BRIEF DESCRIPTION OF DRAWINGS

FIG. 1 illustrates an example big data analytics system, in accordance with an example implementation.

FIG. 2 illustrates an example table join operation, in accordance with an example implementation.

FIG. 3 illustrates an example of the retrieved workload characteristics, in accordance with an example implementation.

FIG. 4 illustrates an example of the retrieved data from transform operations, in accordance with an example implementation.

FIG. 5 illustrates an example of the operation in transform optimization adding an extra transform, in accordance with an example implementation.

FIG. 6 illustrates an example of the operation in transform optimization for removing the extra transform, in accordance with an example implementation.

FIG. 7 illustrates an example of a physical configuration of the system in which the example implementations as described herein may be applied.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein are directed to a big data analytics system utilizing multiple analytics subsystems including hardware accelerators by optimizing data transform between the subsystems.

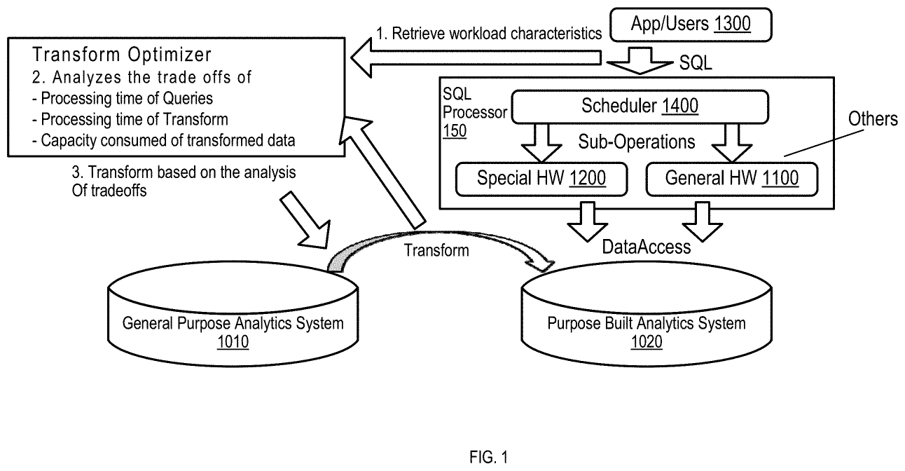

FIG. 1 illustrates an example big data analytics system, in accordance with an example implementation. The system can involve a general purpose analytics system, purpose built analytics system with SQL processors, transform optimizer, and applications using the system.

The SQL processors includes special hardware optimized for at least a part of the SQL operations, and general hardware for covering the other operations. The data stored in the purpose built analytics systems are ingested from the general purpose analytics system with data transformations. The transformations include format transformation, table join, or splitting a table to multiple tables. The format transformation includes translating text based human readable format to machine optimized format, or row-based format to column-based format, such as translating from JavaScript Object Notation/Comma-Separated Value (JSON/csv) to parquet format.

As illustrated in FIG. 1, the system can involve the combination of multiple analytics systems with differing storage systems for each of the multiple analytics systems. Such data storage can include data stored for the general purpose analytics system 1010, which involves analytics configured to be conducted through the general hardware (HW) 1100, and data stored for the purpose built analytics system 1200, which involves analytics configured to be conducted through the special HW 1200. By combining multiple data storage systems and analytics systems, in the form of a data lake or a data warehouse, the example implementations can thereby focus on the flexibility of performance and can transform operations between the two systems to facilitate the desired implementation. In an example implementation, the purpose built analytics system 1020 can be in the form of an optimized platform such as a data warehouse, whereas the general purpose analytics system 1010 can be implemented as a data lake for flexibility. Through the system of FIG. 1, analytics can be conducted on a single system such as general purpose analytics system 1010 or purpose built analytics system 1020, or users can use a combination of both systems. In such example implementations where both systems are utilized, data is first stored in general purpose analytics system 1010 and then transformed for storage in the purpose built analytics system 102 to be processed by special hardware 1200.

In example implementations described herein, general HW 1100 can include general physical hardware processors such as Central Processing Units (CPUs), whereas special HW 1200 includes specialized hardware such as field programmable gate arrays (FPGAs), tensor units, and other hardware accelerators depending on the desired implementation. Should applications or users 1300 request analytics operations through using the special HW 1200, such data subject to the special HW 1200 is stored in the purpose built analytics system 1200, whereupon the special HW 1200 loads the data and conducts operations according to the function of the special HW 1200, and returns the results to the system.

In example implementations, special HW 1200 is optimized to facilitate special functionality for certain functions so that more performance can be achieved, however, special HW 1200 can only accelerate certain functions of an SQL query and not all functions. That is, special HW 1200 as in itself specific restrictions as to functional capabilities and restrictions (e.g., cannot process more than x rows or y columns, must be a specific dimension or format, etc.) The special HW 1200 is specifically programmed to do some sort of specific operation to provide functions for specific data organized in a specific way. Because the hardware resources are limited, for example, number of calculation units in special HW 1200 is limited, the transform operation should fit the data for such processing.

When receiving SQL queries from applications or users 1300, the SQL processor 1500 processes the SQL query through a scheduler 1400, which is configured to divide the SQL query into sub-operations associated with the query. The scheduler 1400 then dispatches the sub-operations to either the general HW 1100 or the special HW 1200 to best performance for both technologies.

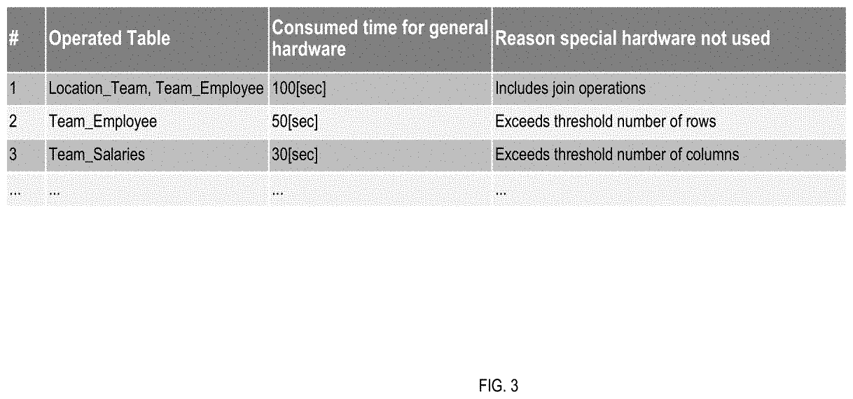

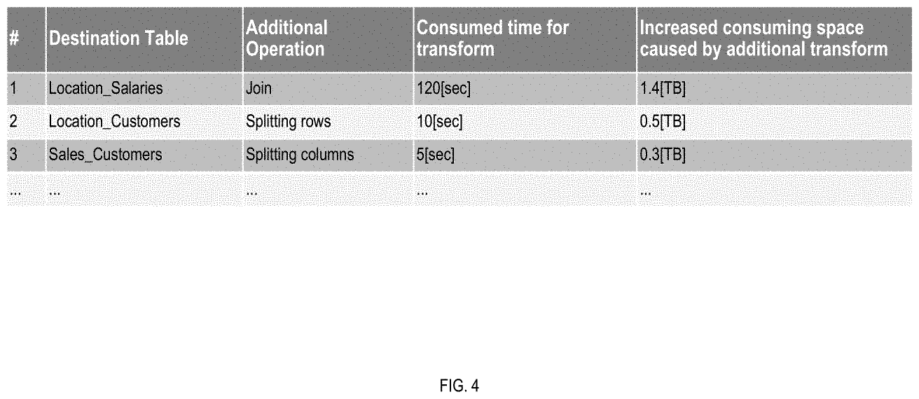

Example implementations described herein are directed to increasing the usage of special HW 1200 on operations for SQL queries as appropriate. Special hardware 1200 can generally only operate on a subset of operations related to an SQL query, thus, example implementations described herein determine appropriate transform operations to reduce the number of operations associated with the SQL query conducted on general HW 1100 and instead have operations processed on special HW 1200 instead. To facilitate such example implementations, the workload characteristics (e.g., pattern of requests from users/applications 1300) are retrieved from the history by the transform optimizer and analyzed to determine what transform operations can be incorporated to convert the operation over to the special HW 1200. Such analysis is balanced against the processing time of the queries, the processing time of conducting such a transform, as well as the capacity consumed for the transformed data, examples of which are shown in FIGS. 3 and 4. For example, the transformed data can increase storage requirements because additional transforms are required. Based on the analytics, the transform operation for the SQL query is modified to facilitate the SQL query for special HW 1200 by the transform optimizer.

As will be described herein, examples of transform operations to data that transforms the data for specialized processing by special HW 1200 can include, but is not limited to, a join operation (e.g., to form a table that meets the size and dimension parameters of the special HW 1200), splitting a table to multiple tables (e.g., for processing individually by special HW 1200 based on the division) dividing the columns (e.g., if special HW 1200 can only operate on a certain number of columns for a table, then the table is divided into multiple columns), text to numbers (e.g., number represents a hash value of the text as recognized by special HW 1200), and so on in accordance with the desired implementation.

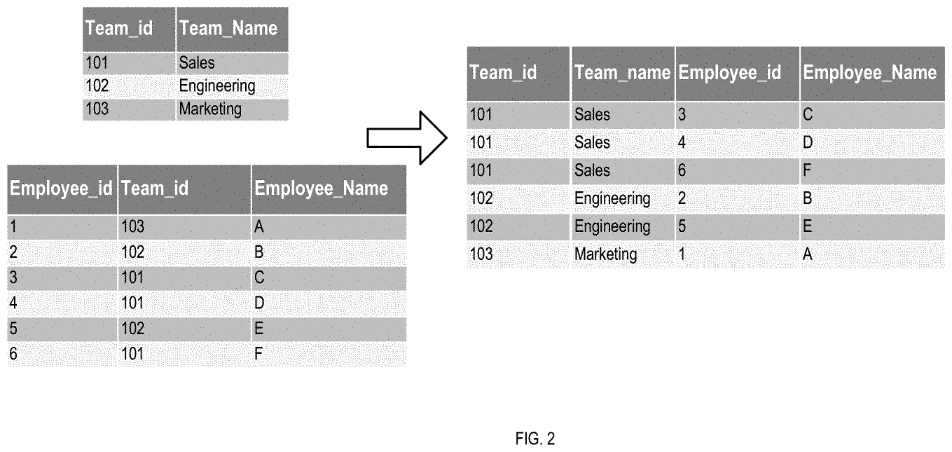

The table join operation includes joining two or more tables having the same type of columns to one table. FIG. 2 illustrates an example table join operation, in accordance with an example implementation. In FIG. 2 the table join operation joins Team table and Employee table into a table including team_id, team_name, employee_id, and employee_name.

The splitting table operation splits a table to multiple tables by row or columns. An example of a splitting table operation can include removing employee_id from the joined table in FIG. 2, or splitting the table into a table with the first three entries table and a table with the last three entries, depending on the desired implementation.

The transform optimizer retrieves the characteristic of SQL queries by monitoring transactions, or receiving histories from the purpose built analytics systems. The transform optimizer also retrieves the computation cost of transform operations. The transform optimizer analyzes the characteristics by using the retrieved information, in terms of processing time of queries, processing time of transform and capacity consumed of storing transformed data in the data store of purpose built analytics system.

Then, the transform optimizer determines the transform operations for the next time such table operations are executed, and reflects the transform operations to the table operations. The optimization can include, for example, adding a join operation for eliminating on-demand join operation at the request of queries, dividing the tables for making the table and queries operatable by the special hardware.

FIG. 3 illustrates an example of the retrieved workload characteristics, in accordance with an example implementation. The workload characteristics can involve multiple entries for the operated table, consumed time for queries, and reason that special hardware were not used. FIG. 3 is retrieving data from SQL, how much time is consumed and why it is not dispatched to the special hardware. Such information can be derived from any method known in the art, such as already existing SQL processes, customized SQL processes, a software monitoring layer, and so on in accordance with the desired implementation.

FIG. 4 illustrates an example of the retrieved data from transform operations, in accordance with an example implementation. The retrieved data from transform operations can include multiple entries of transform destination table, additional operation done in transform operation, consumed additional time for the additional operation, and consuming storage space in the purpose built analytics system caused by the additional transform. FIG. 4 corresponds to retrieving data after transform operations have been conducted, which includes how much the additional transform operation costs in terms of time or storage space. For example, a join operation for table “Location_Salaries” as illustrated in FIG. 4 requires 120 seconds to conduct the transform, and 1.4 terabytes for storing data caused by the transform. Such information can be derived from any method known in the art, such as already existing SQL processes, customized SQL processes, a software monitoring layer, and so on in accordance with the desired implementation.

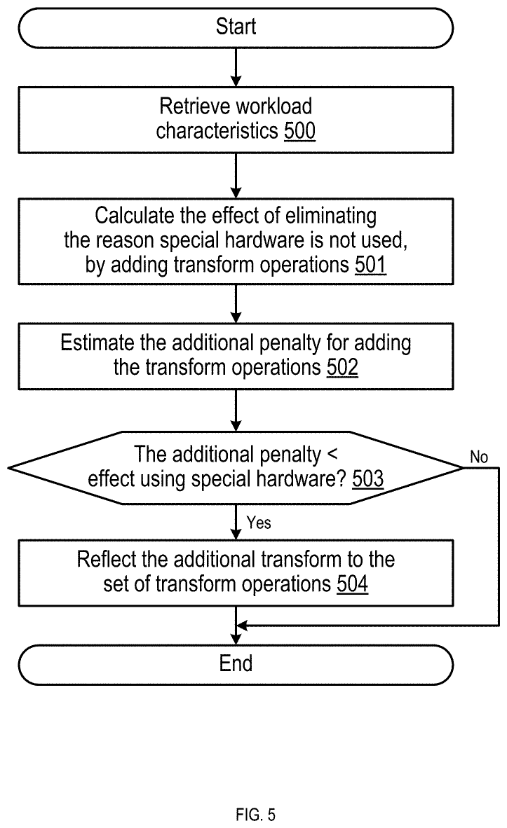

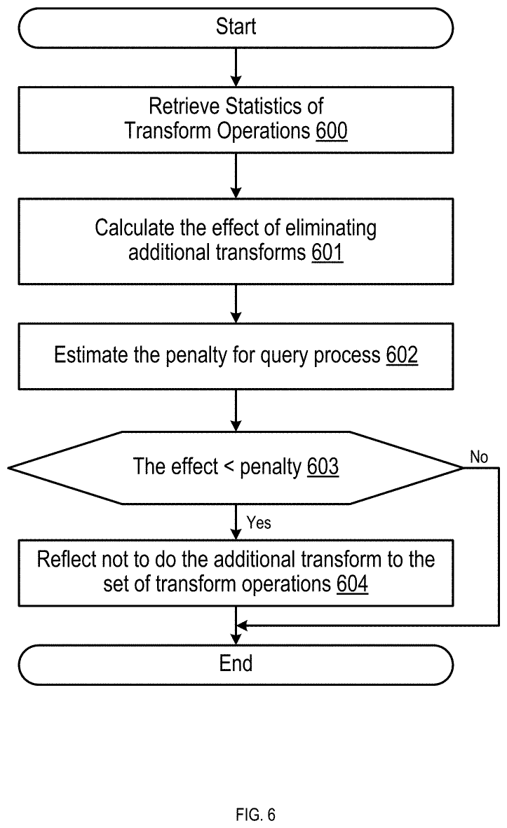

The information illustrated in FIG. 3 and FIG. 4 can be constructed through any desired implementation, such as an additional software layer that monitors queries and how long each query took to process or how much storage space was consumed, related art SQL processes that assemble such information, and so on. Thus, example implementations can constantly monitor the time taken to conduct a query or the time taken to conduct a transform to transform the query for processing by special HW 1200. Such information is then stored as shown in FIGS. 3 and 4 to be processed by the flow diagrams of FIGS. 5 and 6 to determine whether special HW 1200 should be used for the SQL query or not.

FIG. 5 illustrates an example of the operation in transform optimization adding an extra transform, in accordance with an example implementation. Specifically, FIG. 5 illustrates an example flow for determining whether additional transforms are to be added to transform analytics operations to be conducted by the special HW 1200.

At 500, the flow retrieves workload characteristics as described in FIG. 3 and FIG. 4. Then, for the each of the workload characteristics, the flow calculates the effect of eliminating the reason special hardware is not used (e.g., the effect of using special hardware) at 501. The effect is typically the reduced amount of execution time. At 502, the flow estimates the penalty for adding the transform. There is typically extra time taken for executing the transform, or additional space requirement for storage spaces.

At 503, the flow compares the effect and penalty and determines whether or not to add the additional transform. If so (Yes), the flow proceeds to 504, otherwise (No) the flow ends. The comparison method varies according to the desired implementation, but an example comparison could be total computation/storage cost of query and transform, or can involve fulfilling some response time requirement for query, or can involve additional transform cost is acceptable. At 504, the flow reflects the additional transform to the set of transform operations.

For example, in reference of FIGS. 2 to 4, suppose the special HW 1200 requires a join operation to be added between two tables in order to conduct the query on the special HW 1200 instead of the general HW 1100. Suppose the effect of adding the join operation reduces the query operation time by ten seconds versus the general HW 1100 as it is operated on by the special HW 1200. If such an effect outweighs the penalty of adding the join operation (e.g., time taken to conduct the join operation, space requirements to facilitate the data resulting from the join operation, etc.), then the effect can be determined to be sufficient to add the additional transform as illustrated in the flow of 503 and 504.

FIG. 6 illustrates an example of the operation in transform optimization for removing the extra transform, in accordance with an example implementation. Specifically, FIG. 6 illustrates an example flow to determine whether the added transform operation is to be removed or not.

At 600, the flow retrieves the statistics of the transform operations described in FIG. 3 and FIG. 4. At 601, the flow calculates the effect of eliminating additional transforms through a determination as to the additional amount of query time that is added. At 602, the flow estimates the penalty of the query process (e.g., the impact on the query process time). At 603, a determination is made as to whether the effect is larger than the penalty. If so (Yes), the flow proceeds to 604 to determine not to conduct the additional transforms to the set of transform operations (e.g., remove the additional transform), otherwise (No) the flow ends.

For example, suppose the additional transform involves dividing tables for processing by the special HW 1200, which costs additional time for processing the query. Through the flow of FIG. 6, a determination can be made as to whether eliminating the additional transform increases the query time, and if the increase in query time (effect) is less than the penalty from conducting the additional transform (e.g. difference in time saved by using special HW 1200 versus the additional time for processing the query with the dividing tables), then the flow proceeds to 604 to remove the transform for dividing tables.

As illustrated in FIGS. 5 and 6, FIG. 5 can be configured to be invoked by the transform optimizer periodically for operations in which it was previously determined that special HW 120 was not utilized for the SQL query due to the reason indicated in FIG. 3. Accordingly, FIG. 5 is invoked periodically to reanalyze such situations to determine if special HW 120 should be used (e.g., the resulting effect exceeds the penalty in facilitating an improvement). Similarly, FIG. 6 is invoked periodically for SQL queries in which special HW 120 was utilized and refers to the information of FIG. 4 to determine if the system should continue utilizing special HW 120 for such SQL queries.

For the penalty and effect determinations of FIGS. 5 and 6, any function can be utilized to determine the penalty or effect in accordance with the desired implementation, Such functions can be weighted and incorporate factors such as data storage consumed, query time consumed to process the SQL query on general hardware, and transform time consumed to transform the SQL query with the transform operations to process the SQL query on special hardware, depending on the desired implementation. The weights of such functions can also be adjusted in accordance with the desired implementation.

Through the example implementations described herein, the effect of applying special hardware can be improved based on the workload, by changing the transform process before handling the queries. Hence, the example implementations can improve the total performance/resources in multiple analytics systems. Depending on the desired implementation, the example implementations of FIGS. 5 and 6 can be invoked periodically (e.g., every one hour, 10 minutes, etc.) Further, depending on the desired implementation, the example implementations can also periodically determine how many queries were issued and how much time was consumed for each particular query, so that the effect and penalty can be continuously recalculated more precisely based on updated statistics. In another example implementation, if the workload of the system exceeds a certain threshold such that special hardware should be utilized more often, then the example implementations of FIG. 5 can be invoked at that time. Similarly, if the workload on the special hardware exceeds a threshold, then the flow of FIG. 6 can also be invoked at that time. Variations of such example implementations can be facilitated according to the desired implementation.

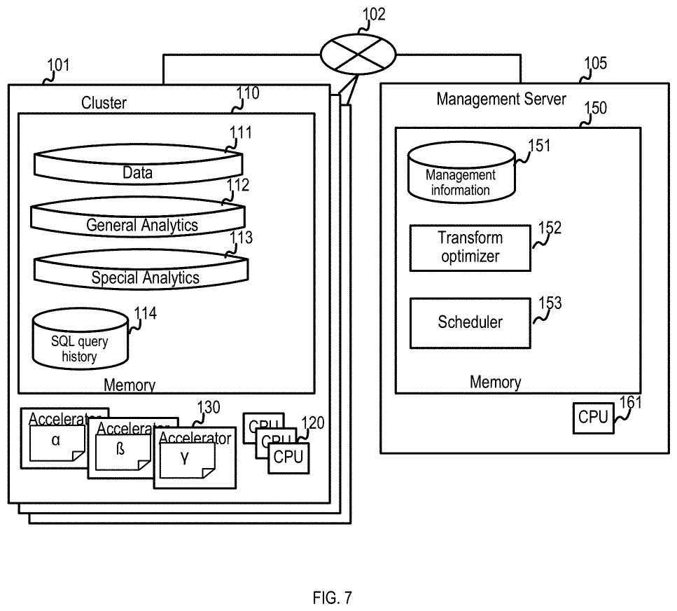

FIG. 7 illustrates an example of a physical configuration of the system in which the example implementations as described herein may be applied. In the example of FIG. 7, the system can include a cluster 101 involving one or more storage systems and servers, each of which can include Memory 110, central processing unit (CPU) 120, and accelerator 130. The Memory 110 is configured to store Data 111, General Analytics 112, Special Analytics 113, and SQL query history 114. CPUs 120 are configured to function as general HW 1100 and can be in the form of one or more physical hardware processors or a combination of hardware and software processors depending on the desired implementation. Accelerators 130 are configured to function as special HW 1200 and can be in the form of physical hardware configured to accelerate software processes or execute software functions in hardware form, such as an FPGA, graphics processing unit (GPU), tensor units, or any other types of special HW 1200 in accordance with the desired implementation.

Management server 105 can include Memory 150 and CPU 161. The Memory 150 is configured to store Management information 151, Transform Optimizer 152, and Scheduler 153. One or more networks 102 can be configured to connect between each of the server/storage systems in cluster 101 and Management server 105. Management information 151 can involve CPU 161 can be configured to load and execute the functions of transform optimizer 152 and scheduler 153. Scheduler 153 is configured to direct the SQL query for processing by CPUs 120 or accelerators 130 in accordance the management information 151 indicating what type of analytics is to be used for the SQL query. Management information 151 is configured to manage information regarding the modified transforms and query operations including workload characteristics and statistics of transform operations as illustrated in FIGS. 3 and 4. In addition, management information 151 can also store a history involving different query operations (e.g., different types of SQL queries) and the associated transforms to be made on such types of query operations for execution on special hardware 130 as determined from the example implementations of FIGS. 5 and 6 as extracted from SQL query history 114. Management information 151 can also store information regarding the types of transform operations that are handled by the special hardware 130 in accordance with the desired implementation. For example, if the special hardware 130 is customized to conduct join operations, split operations, and so on, such information is stored in management information 151. As described herein, the transform operations are operations used to convert/transform the SQL query for processing on the special hardware 130. Accordingly, transform operations can be modified by being associated with query operations and from elimination of such association.

Transform optimizer 152 is configured to execute the flows as illustrated in FIGS. 5 and 6 when loaded on CPU 161. Such execution can be conducted periodically (e.g., every hour, every day), upon receipt of an SQL query, or otherwise in accordance with the desired implementation. Data 111 can involve data stored in a data lake and/or data stored in a data warehouse.

Management server 105 is configured to manage the system such as the cluster 101 involving general hardware 120 for conducting general analytics 112 on a data lake, and special hardware 130 for conducting special analytics 113 on a data warehouse. CPU 161 can load transform optimizer 152 and be configured to receive a history of a Structured Query Language (SQL) query, the history comprising transform operations associated with the SQL query and query operations associated with the SQL query as illustrated in FIGS. 3 and 4 from loading management information 151 into CPU 161; determine a penalty for modifying the transform operations and the query operations associated with the SQL query as illustrated in FIGS. 5 and 6; and based on the history of SQL queries, modify the transform operations and query operations associated with the SQL query for the penalty not exceeding a threshold as illustrated in FIGS. 5 and 6.

For example, CPU 161 can be configured to determine the penalty for modifying transform operations and query operations associated with the SQL query by determining the penalty for modifying the query operations associated with the SQL query to involve the transform operations configured to transform the query operations for processing with the special hardware as illustrated at 502; and determining the threshold, the threshold being an effect for processing the SQL query on the special hardware over processing the SQL query on the general hardware as illustrate at 501 of FIG. 5.

In another example, CPU 161 can be configured to determine the penalty for modifying transform operations and query operations associated with the SQL query by determining the penalty for processing the SQL query on the special hardware over processing the SQL query on the general hardware as illustrated in 602; and determining the threshold, the threshold being an effect for modifying the query operations associated with the SQL query to remove the transform operations configured to transform the query operations for processing with the special hardware as illustrated at 601 in FIG. 6.

In another example, the CPU 161 is configured to modify the transform operations and query operations associated with the SQL query for the penalty not exceeding a threshold comprises one of: removing the transform operations and processing the query operations on the general hardware for a determination of the penalty being based on processing the SQL query on the special hardware over processing the SQL query on the general hardware as illustrated at 603 and 604 of FIG. 6; and incorporating the transform operations to transform the query operations for processing on the special hardware for a determination of the penalty being based on involving the transform operations configured to transform the query operations for processing with the special hardware as illustrated at 503 and 504 of FIG. 5.

Depending on the desired implementation, the threshold is an effect for modifying the transform operations and the query operations based on one or more of data storage consumed, query time consumed to process the SQL query on the general hardware, and transform time consumed to transform the SQL query with the transform operations to process the SQL query on the special hardware as described with respect to FIG. 5 and FIG. 6.

In an example configuration, the general analytics 112 is implemented in a data lake and the special analytics 113 is implemented in a data warehouse that is separate from the data lake. However, example implementations can also consolidate the data lake and the data warehouse into a single cluster 101 of servers and storage systems that can provide a logical lake. In such an example implementation, the data 111 can be processed for general analytics 112 by transform optimizer 152 directly for general analytics by using CPU 161. In such an example implementation, management server 105 and cluster 101 can be integrated to utilize CPU 161 as the general hardware 1100 for execution on a logical lake facilitated by memory 110, whereas the cluster 101 can involve dedicated accelerators 130 to facilitate the special analytics 113.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method comprising:
receiving a history of a Structured Query Language (SQL) query, the history comprising transform operations associated with the SQL query and query operations associated with the SQL query;
determining a penalty for modifying the transform operations and the query operations associated with the SQL query; and
based on the history of SQL queries, modifying the transform operations and query operations associated with the SQL query for the penalty not exceeding a threshold.

2. The method of claim 1, wherein the determining the penalty for modifying transform operations and query operations associated with the SQL query comprises:
determining the penalty for modifying the query operations associated with the SQL query to involve the transform operations configured to transform the query operations for processing with special hardware; and
determining the threshold, the threshold comprising an effect for processing the SQL query on the special hardware over processing the SQL query on general hardware.

3. The method of claim 1, wherein the determining the penalty for modifying transform operations and query operations associated with the SQL query comprises:
determining the penalty for processing the SQL query on special hardware over processing the SQL query on general hardware;
determining the threshold, the threshold comprising an effect for modifying the query operations associated with the SQL query to remove the transform operations configured to transform the query operations for processing with the special hardware.

4. The method of claim 1, wherein the transform operations are operations used to convert the SQL query for processing on special hardware.

5. The method of claim 1, wherein the modifying the transform operations and query operations associated with the SQL query for the penalty not exceeding a threshold comprises one of:
removing the transform operations and processing the query operations on general hardware for a determination of the penalty being based on processing the SQL query on special hardware over processing the SQL query on the general hardware; and
incorporating the transform operations to transform the query operations for processing on the special hardware for a determination of the penalty being based on involving the transform operations configured to transform the query operations for processing with the special hardware.

6. The method of claim 1, wherein the threshold is an effect for modifying the transform operations and the query operations based on one or more of data storage consumed, query time consumed to process the SQL query on general hardware, and transform time consumed to transform the SQL query with the transform operations to process the SQL query on special hardware.

7. A management server, configured to manage a system comprising general hardware for conducting general analytics on a data lake, and special hardware for conducting special analytics on a data warehouse, the management server comprising:
a processor, configured to:
receive a history of a Structured Query Language (SQL) query, the history comprising transform operations associated with the SQL query and query operations associated with the SQL query;
determine a penalty for modifying the transform operations and the query operations associated with the SQL query; and
based on the history of SQL queries, modify the transform operations and query operations associated with the SQL query for the penalty not exceeding a threshold.

8. The management server of claim 7, wherein the processor is configured to determine the penalty for modifying transform operations and query operations associated with the SQL query by:
determining the penalty for modifying the query operations associated with the SQL query to involve the transform operations configured to transform the query operations for processing with the special hardware; and
determining the threshold, the threshold comprising an effect for processing the SQL query on the special hardware over processing the SQL query on the general hardware.

9. The management server of claim 7, wherein the processor is configured to determine the penalty for modifying transform operations and query operations associated with the SQL query by:
determining the penalty for processing the SQL query on the special hardware over processing the SQL query on the general hardware;
determining the threshold, the threshold comprising an effect for modifying the query operations associated with the SQL query to remove the transform operations configured to transform the query operations for processing with the special hardware.

10. The management server of claim 7, wherein the transform operations are operations used to convert the SQL query for processing on the special hardware.

11. The management server of claim 7, wherein the processor is configured to modify the transform operations and query operations associated with the SQL query for the penalty not exceeding a threshold comprises one of:
removing the transform operations and processing the query operations on the general hardware for a determination of the penalty being based on processing the SQL query on the special hardware over processing the SQL query on the general hardware; and
incorporating the transform operations to transform the query operations for processing on the special hardware for a determination of the penalty being based on involving the transform operations configured to transform the query operations for processing with the special hardware.

12. The management server of claim 7, wherein the threshold is an effect for modifying the transform operations and the query operations based on one or more of data storage consumed, query time consumed to process the SQL query on the general hardware, and transform time consumed to transform the SQL query with the transform operations to process the SQL query on the special hardware.

13. The management server of claim 7, wherein the data lake and the data warehouse are facilitated by a same cluster comprising a plurality of servers and a plurality of storage systems.

14. A non-transitory computer readable medium, storing instructions for executing a process, the instructions comprising:
receiving a history of a Structured Query Language (SQL) query, the history comprising transform operations associated with the SQL query and query operations associated with the SQL query;
determining a penalty for modifying the transform operations and the query operations associated with the SQL query; and
based on the history of SQL queries, modifying the transform operations and query operations associated with the SQL query for the penalty not exceeding a threshold.

15. The non-transitory computer readable medium of claim 14, wherein the determining the penalty for modifying transform operations and query operations associated with the SQL query comprises:
determining the penalty for modifying the query operations associated with the SQL query to involve the transform operations configured to transform the query operations for processing with special hardware; and
determining the threshold, the threshold comprising an effect for processing the SQL query on the special hardware over processing the SQL query on general hardware.

16. The non-transitory computer readable medium of claim 14, wherein the determining the penalty for modifying transform operations and query operations associated with the SQL query comprises:
determining the penalty for processing the SQL query on special hardware over processing the SQL query on general hardware;
determining the threshold, the threshold comprising an effect for modifying the query operations associated with the SQL query to remove the transform operations configured to transform the query operations for processing with the special hardware.

17. The non-transitory computer readable medium of claim 14, wherein the transform operations are operations used to convert the SQL query for processing on special hardware.

18. The non-transitory computer readable medium of claim 14, wherein the modifying the transform operations and query operations associated with the SQL query for the penalty not exceeding a threshold comprises one of:
removing the transform operations and processing the query operations on general hardware for a determination of the penalty being based on processing the SQL query on special hardware over processing the SQL query on the general hardware; and
incorporating the transform operations to transform the query operations for processing on the special hardware for a determination of the penalty being based on involving the transform operations configured to transform the query operations for processing with the special hardware.

19. The non-transitory computer readable medium of claim 14, wherein the threshold is an effect for modifying the transform operations and the query operations based on one or more of data storage consumed, query time consumed to process the SQL query on general hardware, and transform time consumed to transform the SQL query with the transform operations to process the SQL query on special hardware.
